(19) United States
(12) Patent Application Publication
(10) Pub. No.: US 2018/0341920 A1
(43) Pub. Date: Nov. 29, 2018

(54) Facilitating Dynamic Email Content Generation

(71) Applicant: AIRTO, INC., Brooklyn, NY (US)

(72) Inventor: Shi Li, Brooklyn, NY (US)

(21) Appl. No.: 15/997,657

(22) Filed: Jun. 4, 2018

Related U.S. Application Data
(63) Continuation-in-part of application No. 14/043,558, filed on Oct. 1, 2013, now Pat. No. 9,990,682.

(51) Int. Cl. G06Q 10/10; H04L 12/58; G06Q 10/08

(52) U.S. Cl. CPC G06Q 10/107; G06Q 10/087; H04L 51/046

(57) ABSTRACT

Embodiments facilitate delivery and presentation of a dynamic email. A sender may compose the dynamic email with static content and dynamic content placeholders. In some embodiments, the sender may send the dynamic email to a receiver. When presenting the dynamic email, the receiver may request a content generator to generate the dynamic content in the dynamic email. In some embodiments, the sender may send the dynamic email to the content generator first to have it generate the dynamic content and populate the dynamic email first. In some embodiments, the receiver may generate an update request when the dynamic email is presented subsequently after it is initially received and presented. The update request can allow the dynamic content to be updated for presentation.

The present application is a continuation of U.S. Nonprovisional application Ser. No. 14/043,558, filed Oct. 1, 2013, now U.S. Pat. No. 9,990,682, issued Jun. 5, 2018, the disclosure of which are hereby incorporated by reference in their entirety for all purposes.

### BACKGROUND

Exemplary embodiments of the present disclosure relate to facilitating delivery and presenting an email. Email that allows a user to perform a simple action such as tracking a shipment is generally know. In such an email, a button that allows the user to perform the simple action is typically displayed next to the subject of the email in the email in-box. Once clicking the button, the simple action may be performed for the user and a result of the simple action may be displayed to the user through a webpage outside the context of the email. Essentially, the email provides certain specific information regarding the user for completing the action (e.g., the user's name and tracking ID of his/her package being shipped).

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system for facilitating dynamic email content generation, the system including one or more processors configured to execute machine readable instructions, the machine readable instructions when executed cause the one or more processors to perform: receiving a dynamic email content generation request from a sender for facilitating transmission of a dynamic email from the sender to the receiver; generating a dynamic email content based on the dynamic email content generation request; and transmitting the dynamic email content to a receiver according to the dynamic email content generation request; and, wherein generating the dynamic email content includes: request an inventory record system to provide inventory information regarding one or more inventory items; and generating the dynamic email content using the inventory information.

Other embodiments of this aspect include corresponding computer systems, apparatus, and computer programs recorded on one or more computer storage devices, each configured to perform the actions of the methods.

In some embodiments, the one or more processors can further be caused to perform: receiving a dynamic email content update request from the receiver for updating the dynamic email content; obtaining a content update based on the dynamic email content update request; and transmitting the content update to the receiver; and, wherein updating the dynamic email content to obtain a content update further includes: requesting the inventory record system to provide updated information regarding the one or more inventory items; and obtaining the content update using the updated information.

In some embodiments, the dynamic email content generation request can include information regarding the receiver and status information regarding a time period during which the dynamic email is to be active. In those embodiments, the one or more processors can further be caused to perform: assigning an identification record to the dynamic email. Implementations of the described techniques may include hardware, a method or process, or computer software on a computer-accessible medium.

Another general aspect includes a method for facilitating dynamic email content generation, the method including one or more processors configured to execute machine readable instructions, the machine readable instructions when executed cause the one or more processors to perform: receiving a dynamic email content generation request from a sender for facilitating transmission of a dynamic email from the sender to the receiver; generating a dynamic email content based on the dynamic email content generation request; and transmitting the dynamic email content to a receiver according to the dynamic email content generation request; and, where generating the dynamic email content includes: request an inventory record method to provide inventory information regarding one or more inventory items; and generating the dynamic email content using the inventory information.

Other embodiments of this aspect include corresponding computer systems, apparatus, and computer programs recorded on one or more computer storage devices, each configured to perform the actions of the methods.

Implementations may include one or more of the following features. The method further including: receiving a dynamic email content update request from the receiver for updating the dynamic email content; obtaining a content update based on the dynamic email content update request; and transmitting the content update to the receiver; and, wherein updating the dynamic email content to obtain a content update further includes: requesting the inventory record method to provide updated information regarding the one or more inventory items; and obtaining the content update using the updated information. Techniques may include hardware, a method or process, or computer software on a computer-accessible medium.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention claimed. The detailed description and the specific examples, however, indicate only preferred embodiments of the invention. Various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced. In the drawings:

FIG. 1 illustrates an example architecture 100 for facilitating dynamic email in accordance with the disclosure.

FIG. 2A illustrates a given sender may be configured to request the dynamic email content generator to generate one or more dynamic contents for the given dynamic email.

FIG. 2B illustrates a given sender may send a dynamic email to a given receiver.

FIG. 3 illustrates an example sender to illustrate the sender shown in FIGS. 1-2.

FIG. 4 illustrates an example receiver to illustrate the receiver shown in FIGS. 1-2.

FIG. 5 provides an example dynamic email content generator in accordance with the disclosure to illustrate dynamic email content generator shown in FIGS. 1-2.

FIG. 6 illustrates one example of a dynamic email to illustrate the dynamic email shown in FIG. 2.

FIG. 7A illustrates a tracking email indicating a shipping status of a certain package.

FIG. 7B illustrates a seat assignment email indicating current seat assignments of a flight.

FIG. 7C illustrates a seat assignment email indicating current seat assignments in a venue for an event.

FIG. 7D illustrates a search result email indicating one or more items searched by a customer.

FIGS. 7E-F illustrate emails in which a shipping status of an item purchased by a customer is displayed.

FIG. 7G illustrates an email in which certain items are advertised.

FIG. 7H illustrates an email indicating room availability and room map for a hotel.

FIG. 7I illustrates an email indicating ticket availability for an event.

FIG. 8 shows an example inventory record system to illustrate the inventory record system shown in FIGS. 1-2.

FIG. 9 illustrates an example of generating a dynamic content for a dynamic email in accordance with the disclosure.

FIG. 10 illustrates an example of updating a dynamic content for a dynamic email in accordance with the disclosure.

FIG. 11 illustrates an example of obtaining and storing inventory items for generating and/or updating a dynamic email in accordance with the disclosure.

FIG. 12 illustrates an example of obtaining inventory items for generating and/or updating a dynamic email in accordance with the disclosure.

FIG. 13 illustrates an example process 1300 for facilitating dynamic email in accordance with the disclosure.

FIG. 14 illustrates another example process 1400 for facilitating dynamic email in accordance with the disclosure.

FIG. 15 illustrates a simplified computer system that can be used implement various embodiments described and illustrated herein.

### DETAILED DESCRIPTION

Various example embodiments of the present disclosure will be described below with reference to the drawings constituting a part of the description. It should be understood that, although terms representing directions are used in the present disclosure, such as “front”, “rear”, “upper”, “lower”, “left”, “right”, and the like, for describing various exemplary structural parts and elements of the present disclosure, these terms are used herein only for the purpose of convenience of explanation and are determined based on the exemplary orientations shown in the drawings. Since the embodiments disclosed by the present disclosure can be arranged according to different directions, these terms representing directions are merely used for illustration and should not be regarded as limiting. Wherever possible, the same or similar reference marks used in the present disclosure refer to the same components.

Unless defined otherwise, all technical terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

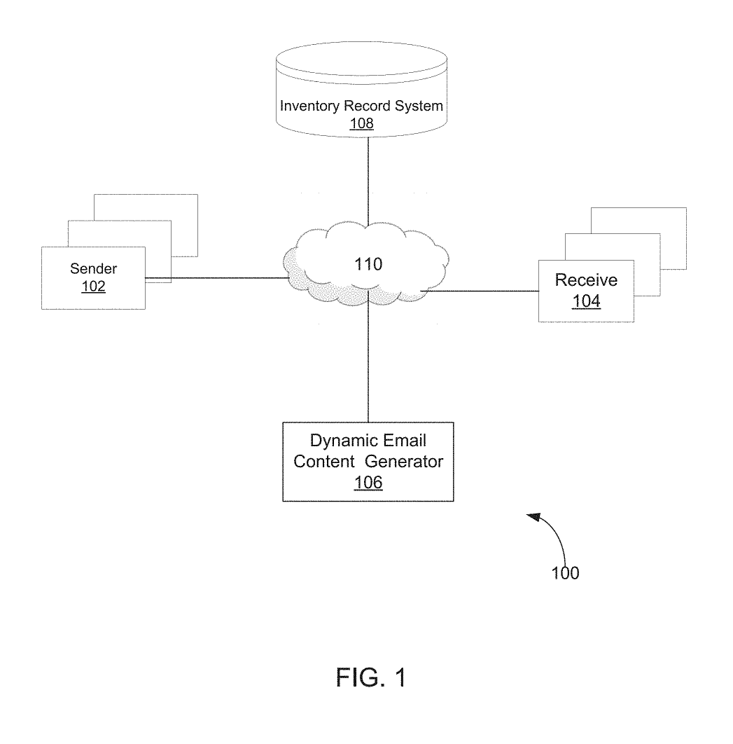

FIG. 1 generally illustrates an example architecture 100 for facilitating dynamic email in accordance with the disclosure. As shown in FIG. 1, the example architecture 100 may comprise one or more senders 102 configured to send dynamic emails. Example architecture 100 may comprise one or more receivers 104 configured to receive dynamic emails sent by the sender(s) 102. In this architecture, the sender(s) 102 and the receiver(s) 104 may be connected to a network 110, for example the Internet. As also shown, the example architecture 100 may comprise a dynamic email content generator 106. In some embodiments, the dynamic email content generator 106 may be configured to facilitate dynamic contents in the dynamic emails sent from the sender(s) 102 to the receiver(s) 104.

Also shown in the example architecture 100 is an inventory record system 108 configured to provide information regarding one or more inventory items. In some embodiments, a given dynamic email in accordance with the disclosure may include the information regarding the one or more inventory items. As can be seen, both the dynamic email content generator 106 and the inventory record system 108 can be connected to the network 110.

In some embodiments, examples of sender(s) 102 may include one or more systems employed by entity such as an airline, a retailer, a content provider, a venue, and/or any other entity. Examples of the receiver(s) 104 may include one or more systems employed by one or more customers of the aforementioned entities. For example, the receiver(s) 104 may include one or more portable smart devices (e.g., a smart phone or a tablet)/laptop computers/desktop computers of the customer(s) of the airline, retailer, content provider, venue, etc.

It should be noted that the dynamic email content generator 106 may or may not be associated with the sender(s) 102 and/or receiver(s) 104. That is, the dynamic email content generator 106 may be, in some embodiment, provided by the sender(s) 102 and/or receiver(s) 104; while in some other embodiments, provided by a party independent from the sender(s) 102 and/or the receiver(s) 104. Likewise, the inventory record system 108 may or may not be associated with the sender(s) 102, the receiver(s) 104, and/or the dynamic email content generator 106.

It should also be noted that the example architecture 100, as suggested by its name, is merely illustrated as an example architecture for facilitating dynamic email between the sender(s) 102 and the receiver(s) 104. That is, the components shown in the example architecture 100 are not intended to be limiting. For instance, functions described and illustrated herein as being attributed to the dynamic email content generator 106 may be distributed on the sender(s) 102, receivers(s) 104, and/or the inventory record system 108. Similarly, functions described and illustrated herein as being attributed to the inventory record system 108 may be distributed on the sender(s) 102, receivers(s) 104, and/or dynamic email content generator 106 in some embodiments.

Still to be noted is that the network 110 illustrated in FIG. 1 is also merely an example connection among sender(s) 102, receiver(s) 104, dynamic email content generator 106, and inventory record system 108. In some embodiments, one or more connections between these components may not necessarily be over the network 110. For example, it is contemplated that the sender(s) 102 and the dynamic email content generator 106 may reside a same system. For example, in some embodiments, a single entity may provide or implement both the sender(s) 102 and the dynamic email content generator 106. Similarly, it is contemplated that in some embodiments, a single entity may provide or implement the dynamic email content generator 106 and the inventory record system 108 on a same system.

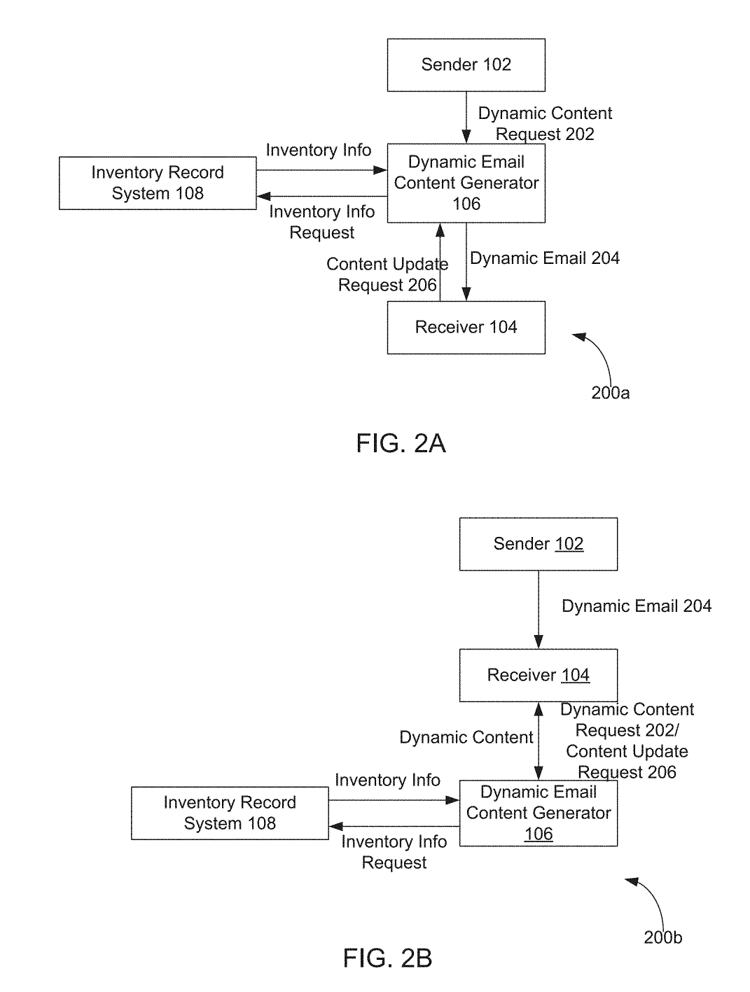

With the example architecture for facilitating the dynamic email between the sender(s) 102 and receiver(s) 104 having been generally described, attention is now directed to FIGS. 2A-2B, illustrating example processes 200a and 200b in which transmission of a given dynamic email in accordance with the disclosure is facilitated. They will be described with reference to FIG. 1. FIG. 2A illustrates, in some embodiments, a given sender 102 may be configured to request the dynamic email content generator 106 to generate one or more dynamic contents for the given dynamic email. As can be seen, in this example, the given sender 102 may be configured to generate a dynamic content request 202 and transmit the dynamic content request 202 to the dynamic email content generator 106. In implementations, the dynamic content request 202 may include information such as identity of one or more intended receivers 104, identity of the given sender 102, email information regarding the one or more intended receivers 104, one or more placeholders for displaying inventory items to be included in the dynamic email, status information regarding the given dynamic email and/or any other information. In some embodiments, the status information regarding the given dynamic email may include the information indicating a period in which the given dynamic email may be valid. For example, the status information may indicate the given dynamic email may be valid for 7 days from a specific time. In some embodiments, the status information may include an ID to identify the given dynamic email.

As shown, after receiving the dynamic content request 202, the dynamic email content generator 106 may be configured to generate a dynamic content for the given dynamic email 204 according to the dynamic content request 202. As shown, for achieving this, the dynamic email content generator 106 may be configured to generate an inventory information request and transmit the inventory information request to the inventory record system 108, which may be configured to provide the requested inventory information and transmit the requested inventory information to the dynamic email content generator 106.

In some embodiments, as shown, the dynamic email content generator 106 may be configured to generate the given dynamic email according to the dynamic content request 202 after the inventory information is received from the inventory record system 108. In those embodiments, the dynamic email content generator 106 may be configured to transmit the given dynamic email to the given receiver 104 for presentation.

As still shown, the given receiver 104 may be configured to generate an update request 206 and transmit the update request 206 to dynamic email content generator 106. For example, after the given dynamic email 204 is received by the given receiver 104 and presented for the first time through a client software associated with the given receiver 104, the given receiver 104 may receive a content update request from the client software. For example, an email client associated with the given receiver 104 may generate such a content request when the given dynamic email is presented subsequently on the email client.

After receiving such a content update request, the given receiver 104 may be configured to generate the content update request 206 and transmit the content update request 206 to the dynamic email content generator 106. After receiving the content update request 206, the dynamic email content generator 106 may be configured to update the content for the given dynamic email 204. In some embodiments, this may again involve requesting, by the dynamic email content generator 106, the inventory record system 108 to provide updated inventory information for the given dynamic email 204.

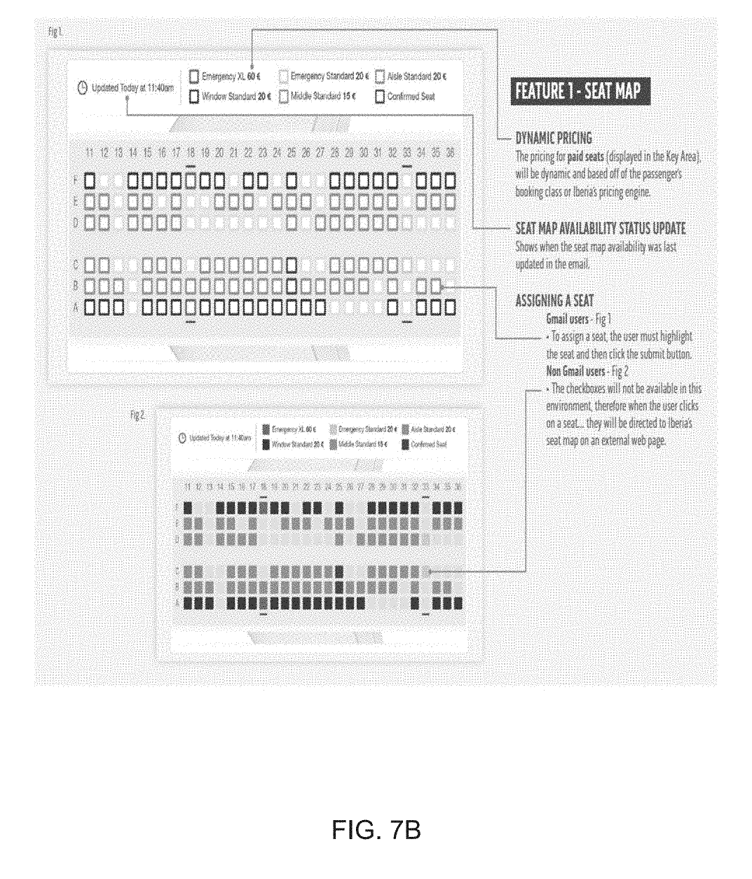

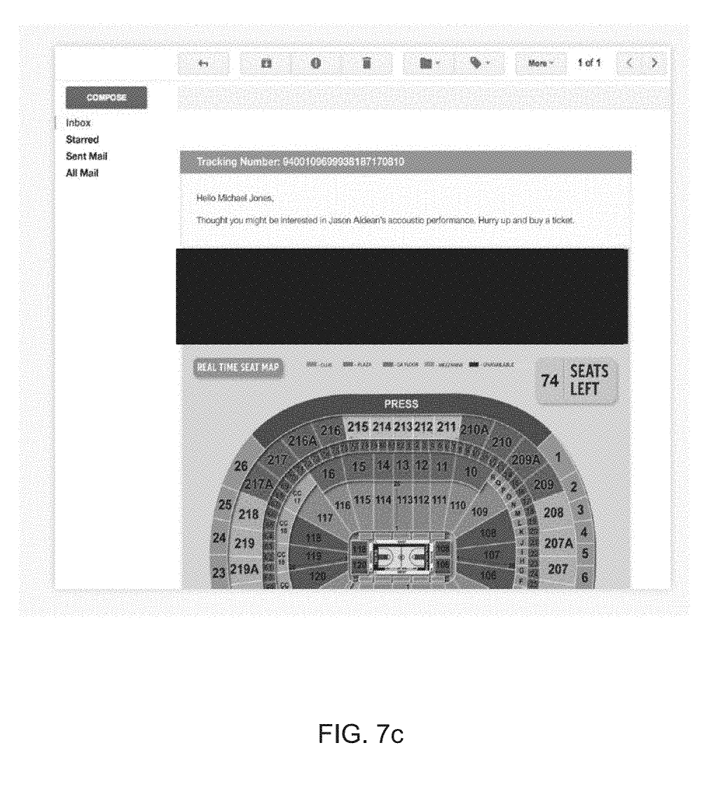

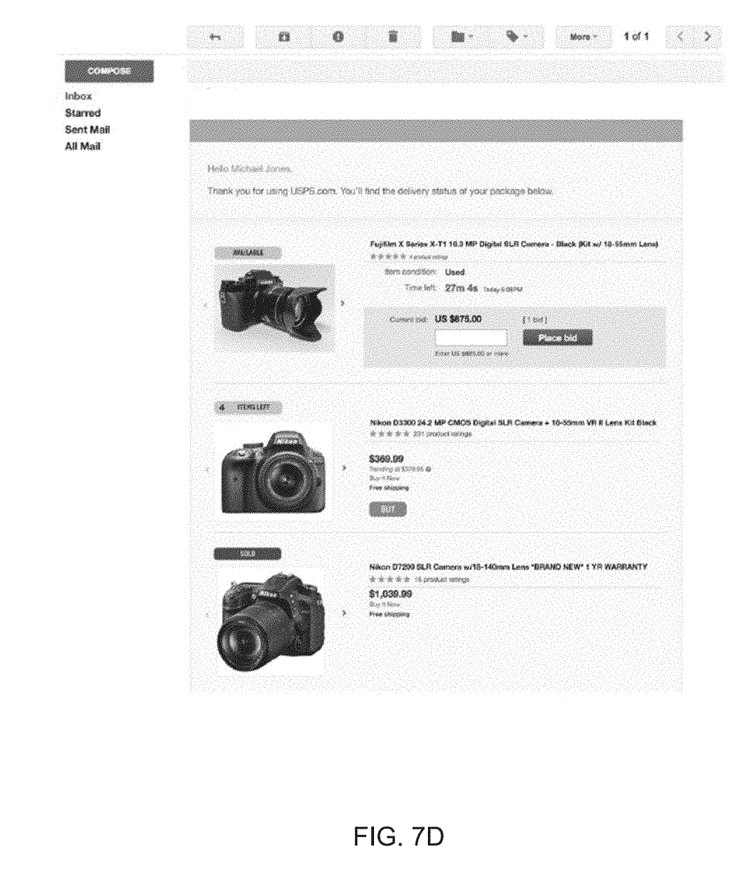

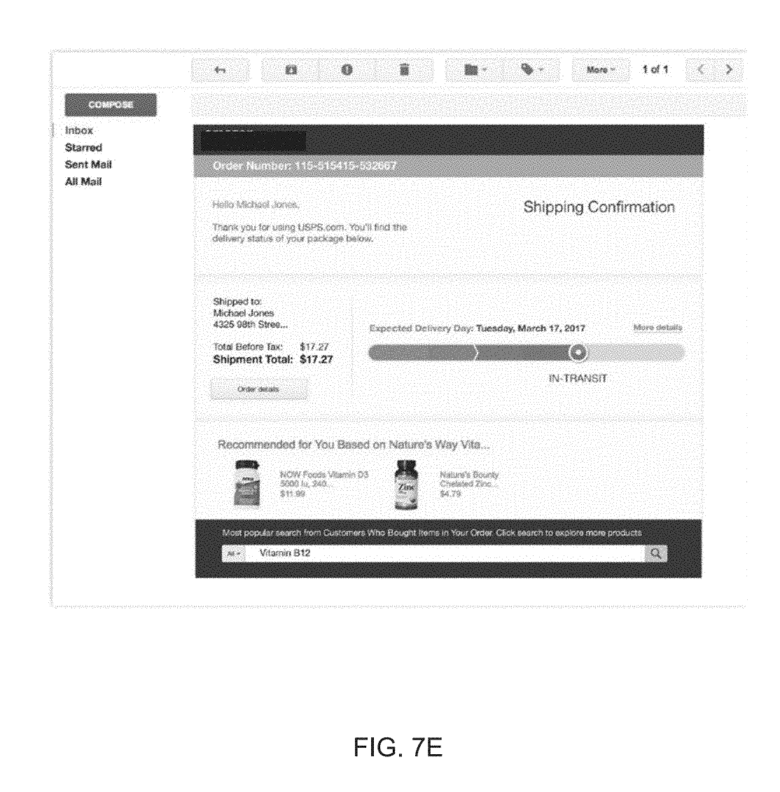

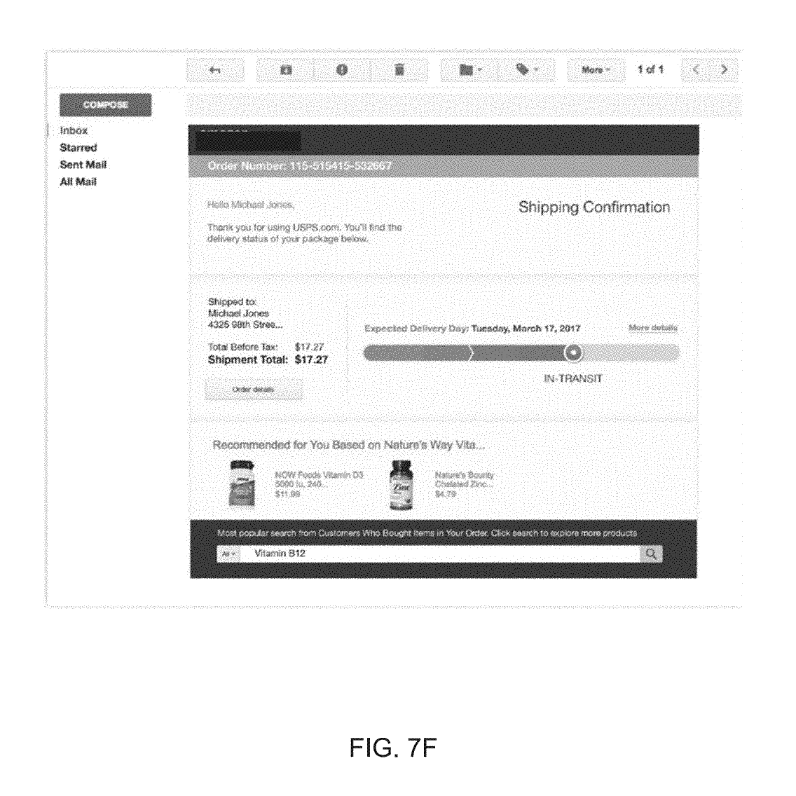

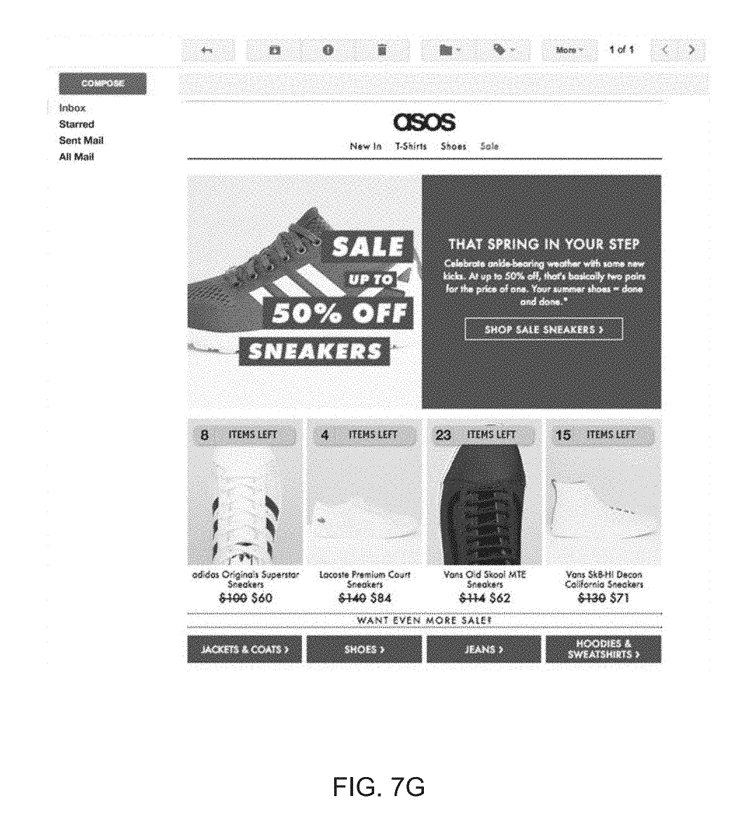

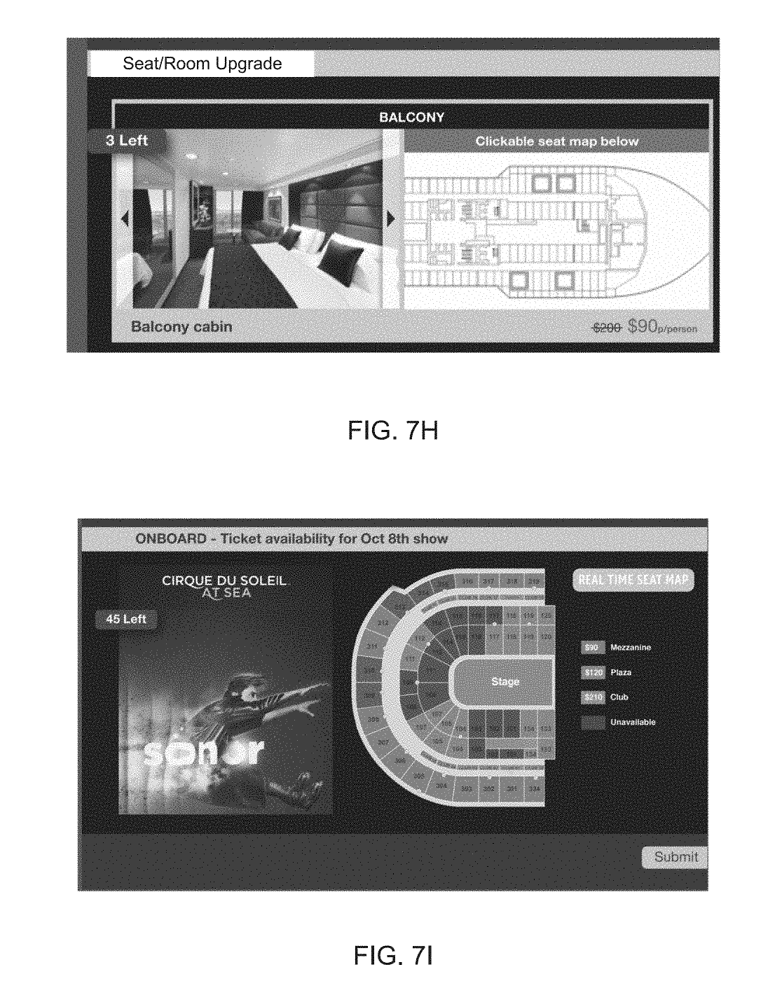

FIG. 2B illustrates, in some embodiments, a given sender 102 may send a dynamic email 204 to a given receiver 104. In those embodiments, the dynamic email 204 may include static content, dynamic content, and/or any other type of contents. The static content may include content that has been already composed by the sender 102 and may not change through a life-time of the dynamic email 204. The dynamic content may include content that may change through the life-time of the dynamic email 204. FIGS. 7A-I illustrate some examples of a dynamic email 204.

As shown in 2B, in those embodiments, after receiving the dynamic email 204, the receiver 104 may generate a dynamic content request 202 for presenting the dynamic content and transmit the dynamic content request 202 to a dynamic email content generator 106. As shown, after receiving the dynamic content request 202, the dynamic email content generator 106 may be configured to generate a dynamic content for the given dynamic email 204 according to the dynamic content request 202. As shown, for achieving this, the dynamic email content generator 106 may be configured to generate an inventory information request and transmit the inventory information request to the inventory record system 108, which may be configured to provide the requested inventory information and transmit the requested inventory information to the dynamic email content generator 106.

As still shown in FIG. 2B, the given receiver 104 may be configured to generate an update request 206 and transmit the update request 206 to dynamic email content generator 106. For example, after the given dynamic email 204 is received by the given receiver 104 and presented for the first time through a client software associated with the given receiver 104, the given receiver 104 may receive a content update request from the client software. For example, an email client associated with the given receiver 104 may generate such a content request when the given dynamic email is presented subsequently on the email client.

As still shown in FIG. 2B, after receiving such a content update request, the given receiver 104 may be configured to generate the update request 206 and transmit the update request 206 to the dynamic email content generator 106. After receiving the update request 206, the dynamic email content generator 106 may be configured to update the content for the given dynamic email 204. In some embodiments, this may again involve requesting, by the dynamic email content generator 106, the inventory record system 108 to provide updated inventory information for the given dynamic email 204.

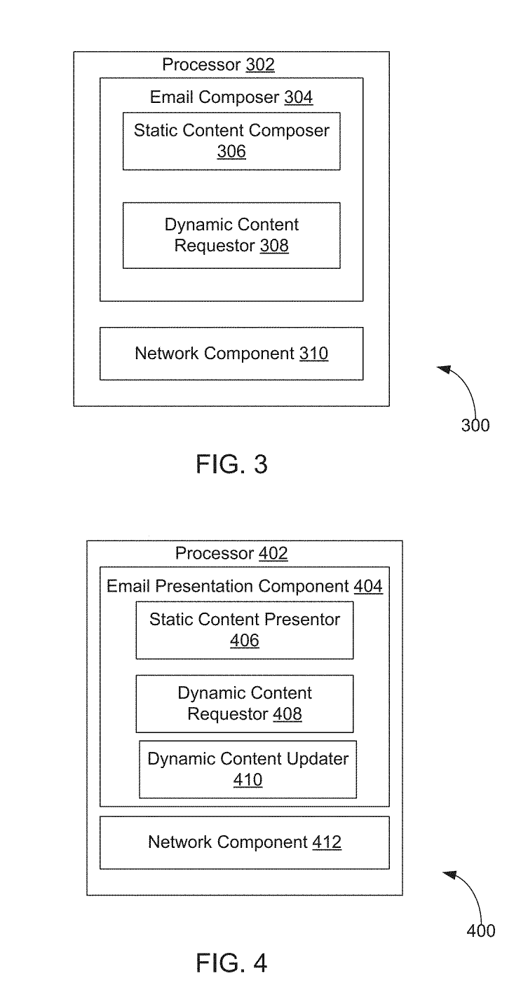

FIG. 3 illustrates an example sender 300 to illustrate the sender 102 shown in FIG. 1 and FIG. 2. As can be seen, in this example, the sender 300 includes one or more of processor 302 configured to execute computer programs. The computer programs can include an email composer 304, a network component 310, and/or any other components. In some embodiments, the email composer 304 may include an email client, which a user may use to compose a dynamic email such as the dynamic email 204 shown in FIG. 2. In this example, the email composer 304 includes a static content composer 306, a dynamic content requestor 308, and/or any other components.

The static content composer 306 may be configured to generate static email content for inclusion in a dynamic email composed by the email composer 304. As described above, the static content may include content that may not change through a life-time of the dynamic email 204. Such email content may be provided by a user or a program associated with the email composer 304. For example, an administrator of a company that uses email composer 304 may provide the static email content.

The dynamic content requestor 308 may be configured to generate a dynamic content request such as dynamic content request 202 shown in FIG. 2 for populating the dynamic content of the dynamic email. The dynamic content request may be used to facilitate generating dynamic content for the dynamic email composed by the email composer 304. As described above, the dynamic content may include content that may change through the life-time of the dynamic email 204.

As shown, the sender 300 may include a network component 310. The a network component 310 may be configured to transmit the dynamic email composed by the email composer 304. The dynamic email be transmitted by the network component 412 to a receiver (such as the receiver 104) and/or a dynamic email content generator (such as dynamic email content generator 106) over a network, such as the Internet.

FIG. 4 illustrates an example receiver 400 to illustrate the receiver 104 shown in FIG. 1 and FIG. 2. As can be seen, in this example, the receiver 400 includes one or more of processor 402 configured to execute computer programs. The computer programs can include an email presentation component 404, a network component 412 and/or any other components. In some embodiments, the email presentation component 404 may include an email client, which may be configured to receive a dynamic email such as the dynamic email 204 and to display the dynamic email. In this example, the email presentation component 404 includes a static content presenter 406, a dynamic content requestor 408, a dynamic content updater 410 and/or any other components.

The static content presenter 406 may be configured to present static email content in a dynamic email received by email presentation component 404. The dynamic content requestor 408 may be configured to obtain or generate a dynamic content request such as dynamic content request 202 shown in FIG. 2. The dynamic content request may be used to facilitate presenting the dynamic content for the dynamic email on the receiver. In a sense, the dynamic content requestor 408 may provide an user interactive aspect when facilitating the dynamic email. For example, a user may click certain content in the dynamic email (such as a button in the email to have a detailed view of all current seat assignments in a flight reserved by the user). In that example, after the click by the user is received, a dynamic content requestor 408 may be configured to generate the dynamic content request for facilitating the presentation of dynamic content in the dynamic email (e.g., requesting the inventory record system to provide the current seat assignments for the flight). The dynamic content updater 410 may be configured to generate an update request such as the update request 206 shown in FIG. 2. For example, a user may click a flight reservation email (which the user has already received and viewed earlier) one day before she/he checks in for the flight to see an updated seat assignment for the flight. In that example, after the click by the user is received, the dynamic content updater 410 may be configured to generate the dynamic content request for facilitating the presentation of the updated dynamic content in the dynamic email (e.g., requesting the inventory record system to provide an updated seat assignments for the flight).

As shown, the network component 412 may be configured to transmit the dynamic content request and/or the dynamic content update request to a dynamic email content generator such as the dynamic email content generator 106 shown in FIG. 1 and FIG. 2. The dynamic content request and/or the dynamic content update request may be transmitted by the network component 412 to a receiver (such as the receiver 104) and/or a dynamic email content generator (such as dynamic email content generator 106) over a network, such as the Internet.

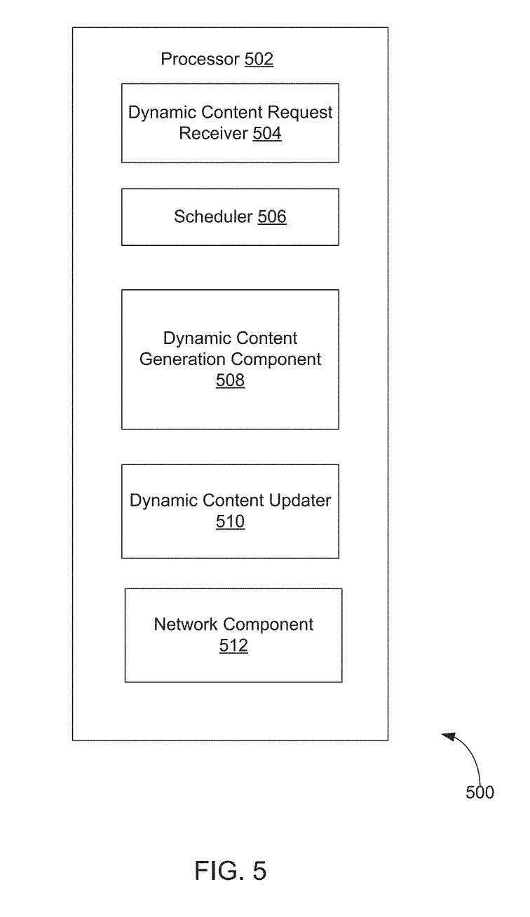

FIG. 5 provides an example dynamic email content generator 500 in accordance with the disclosure to illustrate dynamic email content generator 106 shown in FIG. 1 and FIG. 2. As shown, the dynamic email content generator 500 may include one or more of a processor 502 configured to execute computer programs, which may include a dynamic content request receiver 504, a scheduler 506, a dynamic content generation component 508, a dynamic content updater 510, a network component 512, and/or any other components.

The dynamic content request receiver 504 may be configured to receive a dynamic content request transmitted from a sender or a receiver of a dynamic email. As described above, the dynamic content request may include information indicating one or more items in a dynamic email may need to be generated (e.g., after a static portion of the dynamic email has already been composed by the sender). Such a request may include information indicating an identification of the dynamic email associated with the dynamic content request. This identification can help the dynamic email content generator 500 track and manage individual dynamic content requests it receives over a time period. A given dynamic content request may include information indicating an identification of a third party provider that may provide the dynamic content for generating the dynamic content requested by the dynamic content request. In some embodiments, such a request may include information indicating a validity period of the request such that the request has to be satisfied by the dynamic email content generator 500 within this period or else the dynamic email content generator 500 should discard this request.

In some embodiments, the dynamic content request receiver 504 may be configured to receive dynamic content update request from the sender or receiver of a dynamic email. As described above, the dynamic content update request may be transmitted by, for example, the receiver of the dynamic email for updating the dynamic content of the dynamic email. This may happen when a user associated with the receiver displays the dynamic email after the dynamic email has been first presented. For example, the user may open the dynamic email again after he/she has opened the dynamic email for the first time (perhaps one day later) to check certain information in the dynamic email (for example his/her seat assignment information for a flight). In that example, the receiver may generate a dynamic content update request to update (or to refresh) to the dynamic content of the dynamic email to present the latest information to the user.

The scheduler 506 may be configured to schedule processing the dynamic content request and/or the dynamic content update request received by the dynamic content request receiver 504. In implementations, processing the dynamic content request and/or the dynamic update request may involve contacting one or more a server computer, such as an inventory record system 108 shown in FIG. 1 and FIG. 2. The scheduler 506 may be configured to maintain a schedule for contacting such a server computer. For example, the scheduler 506 may be configured to contact the server computer immediately after the dynamic content request has been received by the dynamic content request receiver 504 to facilitate the dynamic content generation component 508 to generate the dynamic content in accordance with the dynamic content request. In some embodiments, the scheduler 506 may be configured to contact the server computer on a preset cadence (for example once every 4 hours) for updating the dynamic content. In those embodiments, the scheduler 506 may be configured to store the updates (e.g., caching). The cached results can be used to update the dynamic content of a dynamic email presented to the user associated with the receiver when a content update request is received by dynamic content request receiver 504.

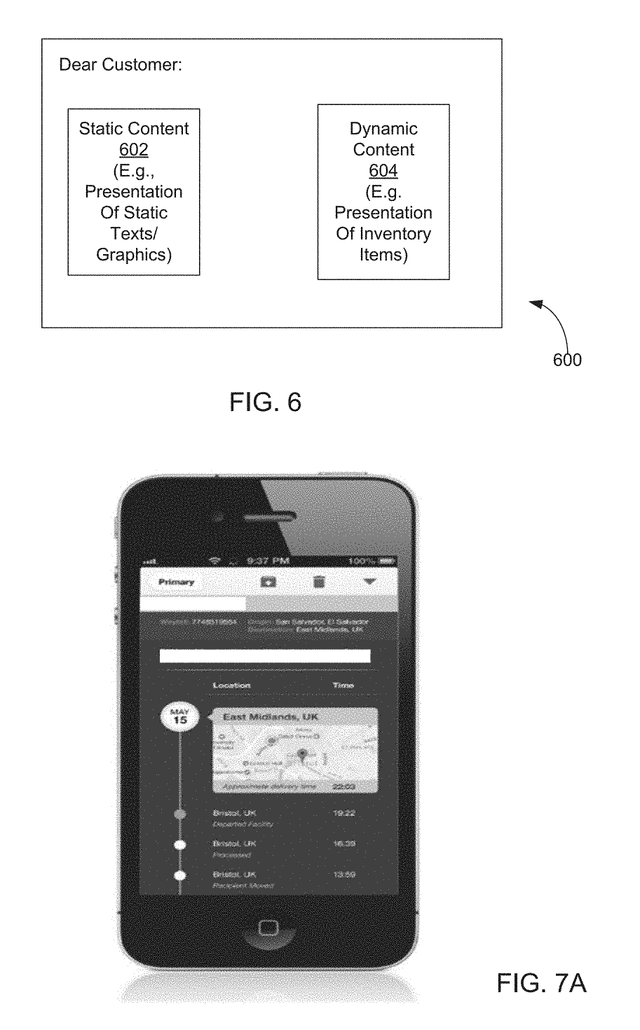

The dynamic content generation component 508 may be configured to generate dynamic content in accordance with the dynamic content request received by the dynamic content generation request receiver. FIG. 6 illustrates one example of a dynamic email 600 to illustrate the dynamic email 204 shown in FIG. 2. As can be seen, a dynamic email in accordance with the disclosure, such as the dynamic email 600 shown in FIG. 6, can include static content 602, dynamic content 604, and/or any other type of content. The static content 602 may include content that has already been composed by the sender (such as static texts) and may not change throughout the lift-time of the dynamic email 600. The dynamic content 604 may include content that may change throughout the life-time of the dynamic email 600. Such content may reflect up-to-date information such as up-to-date inventory information. FIG. 7A-I provide some examples of dynamic email 600.

FIG. 7A illustrates a tracking email indicating a shipping status of a certain package. As can be seen, the shipping status portion of this email can change over the time to reflect where the package is currently. That portion of this email may be referred to as the dynamic content. FIG. 7B illustrates a seat assignment email indicating current seat assignments of a flight. Since the seat assignments can change over the time as passengers select their seats, the seat assignment map in the email can be referred to as the dynamic content of this email. FIG. 7C illustrates a seat assignment email indicating current seat assignments in a venue for an event. Similar to that shown in FIG. 7B, the seat assignment of the venue can change over the time as event-goers select their seats in the venue. FIG. 7D illustrates a search result email indicating one or more items searched by a customer. Since statuses of the items shown in this email can change over time (e.g., their availability and/or pricing), the item portion of this email may be referred to as dynamic content of this email. FIGS. 7E-F illustrate emails in which a shipping status of an item purchased by a customer is displayed. Like FIG. 7A, the shipping status portion of these emails can change over time and thus may be referred to as dynamic content. FIG. 7G illustrates an email in which certain items are advertised. Like, FIG. 7D, statuses of the items shown in this email can change over time (e.g., their availability and/or pricing), the item portion of this email may be referred to as dynamic content of this email. FIG. 7H illustrates an email indicating room availability and room map for a hotel. Since the room availability can change over time, this portion of the email may be referred to as a dynamic content of this email. FIG. 7I illustrates an email indicating ticket availability for an event, like that shown in FIG. 7C, the seat assignment and seat availability information (i.e., how many tickets are currently available for purchase) may be referred to as dynamic content of this email.

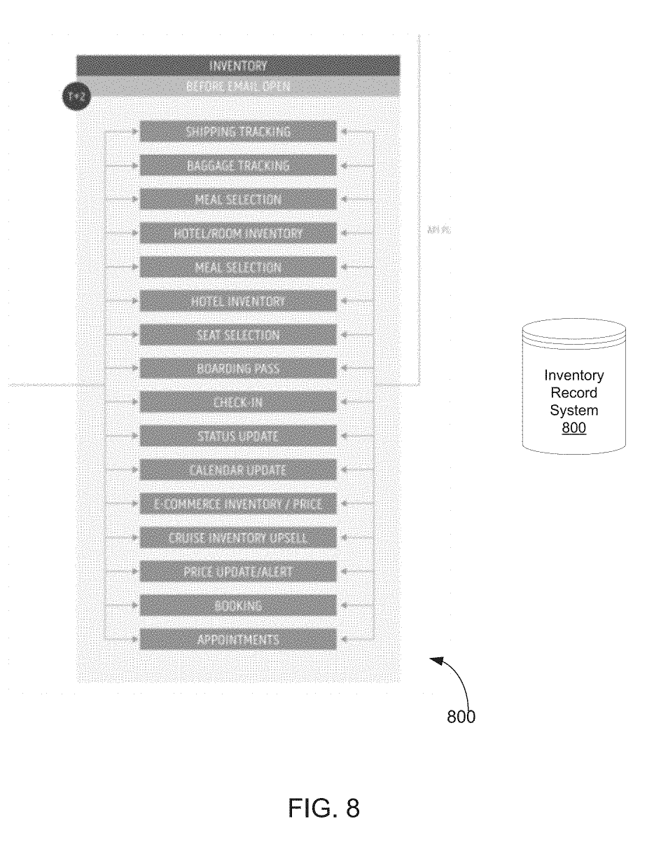

FIG. 8 shows an example inventory record system 800 to illustrate the inventory record system 108 shown in FIG. 1 and FIG. 2. As can be seen, in this example, the inventory record system 800 includes various components that can be configured to serve various type of dynamic contents. These components may be referred to as inventory item components. As shown in FIG. 2, the generation of dynamic content by the dynamic content generation component 508 may involve parsing the dynamic content request received by the dynamic content request receiver 504 and generate one or more inventory item request to obtain one or more inventory items from the inventory record system 800. The inventory items may include seat assignment information for a flight or an event reserved by the user, shipping status information of one or more items of interest to the user, advertising information regarding one or more items that may be of interest to the user, room or ticket availability information for an event or hotel that may be of interest to the user, and/or any other inventory items. The inventory record system 800 may be configured to maintain up-to-date information regarding such information. In some embodiments, the inventory record system 800 may serve as a repository for storing such information obtained from various corresponding providers (e.g., airlines, venue, ecommerce operator, hotel operator, and/or any other providers).

Referring back to FIG. 5, dynamic content updater 510 may be configured to update the dynamic content of a dynamic email. As described above, from time to time, the user associated with the receiver may request to view updated dynamic content of the dynamic email received by the user. For example, the user may open the shipping status email shown in FIG. 7A multiple times after he/she receives that email initially to check where the package is currently. In that example, an content update request may be transmitted from the receiver when the user opens the shipping status information subsequently and may be received by the dynamic content request receiver 504. After receiving such an content update request, the dynamic content updater 510 may update the dynamic content of the dynamic email in accordance with the content update request. This may involve updating inventory information in the dynamic content (e.g., such as the up-to-date shipping status, the up-to-date seat assignment information). In some embodiments, the dynamic content updater 510 can be configured to generate inventory item requests, transmit such requests to the inventory record system 800, and receive the request inventory items from the inventory record system 800. For example, the dynamic content updater 510 may request the inventory record system 800 to provide the up-to-date shipping status information for the package indicated in the dynamic email.

The network component 512 may be configured to transmit and/or receive various requests and/or contents mentioned above over a network. The various requests may include the dynamic content request, the content update request, the inventory item request and/or any other request. The various contents may include the dynamic content generated by the dynamic content generation component 508, the updated dynamic content by the dynamic content updater 510, and/or any other contents.

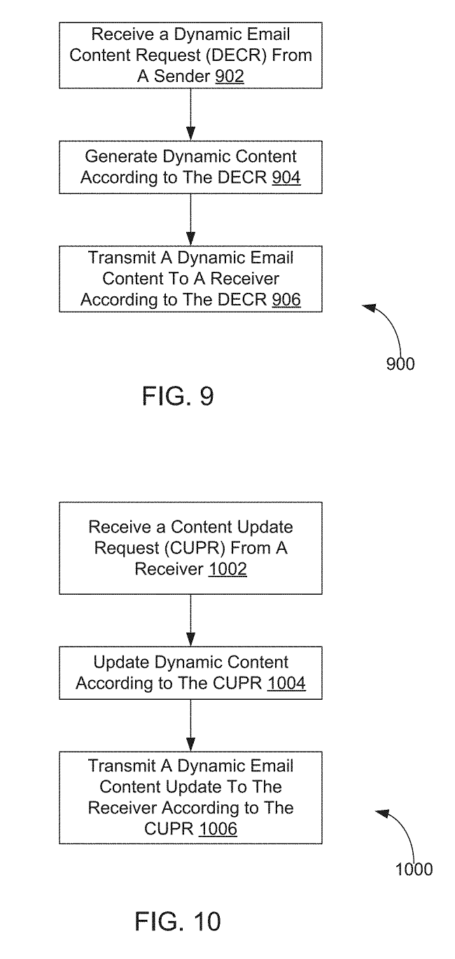

FIG. 9 illustrates an example of generating a dynamic content for a dynamic email in accordance with the disclosure. The method presented in FIG. 9 and described below is intended to be illustrative and non-limiting. The particular series of processing steps depicted in FIG. 9 is not intended to be limiting. It is appreciated that the processing steps may be performed in an order different from that depicted in FIG. 9 and that not all the steps depicted in FIG. 9 need be performed. In certain implementations, the method 900 may be implemented by a dynamic email content generator, such as the dynamic email content generator 106 shown in FIG. 1. FIG. 9 will be described with reference to FIG. 1.

In some embodiments, the method depicted in method 900 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 900 in response to instructions stored electronically on an electronic storage medium. The one or more processing devices may include one or more devices configured through hardware, firmware, and/or software to be specifically designed for execution of one or more of the operations of method 900.

At 902, a dynamic email content request (DECR) can be received from a sender, such as the sender 102 shown in FIG. 1. In some embodiments, the DECR may be embedded in a dynamic email composed by the sender. In those embodiments, once the dynamic email is sent by the sender, the DECR in the dynamic email may be received at 902. In some other embodiments, the DECR may be received from the receiver, such as the receiver 104 shown in FIG. 1. In those embodiments, the receiver may request the dynamic content to be generated for presenting a dynamic email received by the receiver. In some implementations, operations involved in 902 may be implemented by a dynamic content generation request receiver the same or substantially similar to the dynamic content request receiver 504 illustrated and described herein.

At 904, the dynamic content requested by the DECR received at 902 can be generated according to the DECR. Generation of the dynamic content item may involve parsing the DECR, obtaining from the DECR information for how to populate the dynamic content, generating one or more inventory item requests for based on the obtained information, transmitting the inventory item requests to an inventory record system, receiving the requested inventory items, populating the dynamic content with the inventory items (e.g., placing the inventory items in one or more inventory item place holders in the DECR), and/or any other operations. In some implementations, operations involved in 904 may be implemented by dynamic content generation component the same or substantially similar to the dynamic content generation component 508 illustrated and described herein.

At 906, the dynamic content generated at 904 may be transmitted to the receiver of the dynamic email according to the DECR. In some implementations, operations involved in 904 may be implemented by network component the same or substantially similar to the network component 512 illustrated and described herein.

FIG. 10 illustrates an example of updating a dynamic content for a dynamic email in accordance with the disclosure. The method presented in FIG. 10 and described below is intended to be illustrative and non-limiting. The particular series of processing steps depicted in FIG. 10 is not intended to be limiting. It is appreciated that the processing steps may be performed in an order different from that depicted in FIG. 10 and that not all the steps depicted in FIG. 10 need be performed. In certain implementations, the method 1000 may be implemented by a dynamic email content generator, such as the dynamic email content generator 106 shown in FIG. 1. FIG. 10 will be described with reference to FIG. 1.

In some embodiments, the method depicted in method 1000 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1000 in response to instructions stored electronically on an electronic storage medium. The one or more processing devices may include one or more devices configured through hardware, firmware, and/or software to be specifically designed for execution of one or more of the operations of method 1000.

At 1002, a content update request (CUPR) for a dynamic email can be received from a receiver, such as the sender 102 shown in FIG. 1. As described above, since the dynamic content of the dynamic email can change over time, the receiver may from time to time to request an update of the dynamic content through a CUPR for presenting the dynamic email to the user subsequently after the dynamic email is received by the receiver initially. In some implementations, operations involved in 1002 may be implemented by a dynamic content generation request receiver the same or substantially similar to the dynamic content request receiver 504 illustrated and described herein.

At 1004, the dynamic content requested by the CUPR received at 1002 can be updated according to the CUPR. Updating of the dynamic content item may involve parsing the CUPR, obtaining from the CUPR information for how to populate the dynamic content, generating one or more inventory item requests for based on the obtained information, transmitting the inventory item requests to an inventory record system, receiving the requested inventory items, updating the dynamic content with the inventory items (e.g., placing the inventory items in one or more inventory item place holders in the CUPR), and/or any other operations. In some implementations, operations involved in 1004 may be implemented by a dynamic content updater the same or substantially similar to the dynamic content updater 510 illustrated and described herein.

At 1006, the dynamic email content generated at 1004 may be transmitted to the receiver of the dynamic email according to the CUPR. In some implementations, operations involved in 1004 may be implemented by network component the same or substantially similar to the network component 512 illustrated and described herein.

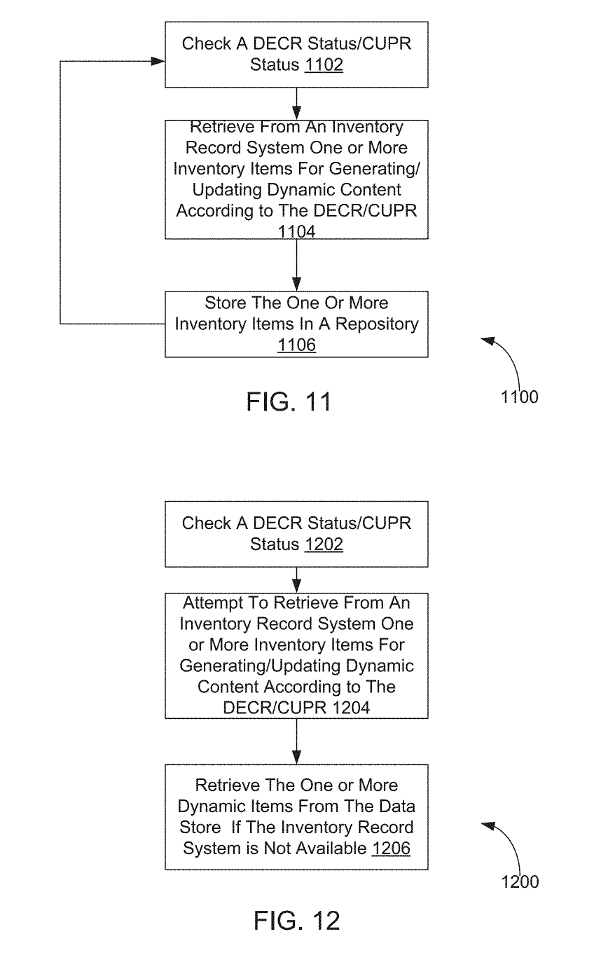

FIG. 11 illustrates an example of obtaining and storing inventory items for generating and/or updating a dynamic email in accordance with the disclosure. The method presented in FIG. 11 and described below is intended to be illustrative and non-limiting. The particular series of processing steps depicted in FIG. 11 is not intended to be limiting. It is appreciated that the processing steps may be performed in an order different from that depicted in FIG. 11 and that not all the steps depicted in FIG. 11 need be performed. In certain implementations, the method 1100 may be implemented by a dynamic email content generator, such as the dynamic email content generator 106 shown in FIG. 1. FIG. 11 will be described with reference to FIG. 1.

In some embodiments, the method depicted in method 1100 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1100 in response to instructions stored electronically on an electronic storage medium. The one or more processing devices may include one or more devices configured through hardware, firmware, and/or software to be specifically designed for execution of one or more of the operations of method 1100.

At 1102, a status of a DECR or a CUPR can be checked. Such status checking may involve checking whether the dynamic email for the DECR or CUPR has expired. For example, the dynamic email may have a validity period during which the dynamic email can be presented to the user. For instance, a dynamic email indicating seat assignment for a flight may only be valid before the flight actually departs. At 1102, the status of DECR or CUPR is checked to ensure whether it is necessary to generate or update dynamic content for the dynamic email after a DECR or CUPR is received. In some implementations, operations involved in 1102 may be implemented by a scheduler the same or substantially similar to the scheduler 506 illustrated and described herein.

At 1104, one or more inventory items can be retrieved from an inventory record system for generating and/or updating the dynamic content according to the DECR/CUPR.

In some embodiments, step 1104 may be performed after the status checking at 1102 indicates that DECR/CUPR is still valid. In some implementations, operations involved in 1104 may be implemented by dynamic content generation component/a dynamic content updater the same or substantially similar to dynamic content generation component 508/the dynamic content updater 510 illustrated and described herein.

At 1106, the one or more inventory items retrieved at 1104 can be stored in a repository for later generating or updating the dynamic content. In some implementations, operations involved in 1106 may be implemented by a scheduler the same or substantially similar to the scheduler 506 illustrated and described herein.

FIG. 12 illustrates an example of obtaining inventory items for generating and/or updating a dynamic email in accordance with the disclosure. The method presented in FIG. 12 and described below is intended to be illustrative and non-limiting. The particular series of processing steps depicted in FIG. 12 is not intended to be limiting. It is appreciated that the processing steps may be performed in an order different from that depicted in FIG. 12 and that not all the steps depicted in FIG. 12 need be performed. In certain implementations, the method 1200 may be implemented by a dynamic email content generator, such as the dynamic email content generator 106 shown in FIG. 1. FIG. 12 will be described with reference to FIG. 1.

In some embodiments, the method depicted in method 1200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1200 in response to instructions stored electronically on an electronic storage medium. The one or more processing devices may include one or more devices configured through hardware, firmware, and/or software to be specifically designed for execution of one or more of the operations of method 1200.

At 1202, a status of a DECR or a CUPR can be checked. Such status checking may involve checking whether the dynamic email for the DECR or CUPR has expired. For example, the dynamic email may have a validity period during which the dynamic email can be presented to the user. For instance, a dynamic email indicating seat assignment for a flight may only be valid before the flight actually departs. At 1202, the status of DECR or CUPR is checked to ensure whether it is necessary to generate or update dynamic content for the dynamic email after a DECR or CUPR is received. In some implementations, operations involved in 1202 may be implemented by a scheduler the same or substantially similar to the scheduler 506 illustrated and described herein.

At 1204, retrieval of one or more inventory items from an inventory record system can be attempted for generating and/or updating the dynamic content according to the DECR/CUPR. In some embodiments, step 1204 may be performed after the status checking at 1202 indicates that DECR/CUPR is still valid. In some implementations, operations involved in 1204 may be implemented by dynamic content generation component/a dynamic content updater the same or substantially similar to dynamic content generation component 508/the dynamic content updater 510 illustrated and described herein.

At 1206, if the attempt(s) at 1204 fails, the one or more inventory items can be retrieved from a repository for generating or updating the dynamic content in accordance with DECR or CUPR. For example, 1206 may be executed if attempts to retrieve the one or more inventory items are timed out due to the inventory record system being not responsive for a threshold time period (e.g., 5 minutes). In some implementations, operations involved in 1206 may be implemented by a scheduler the same or substantially similar to the scheduler 506 illustrated and described herein.

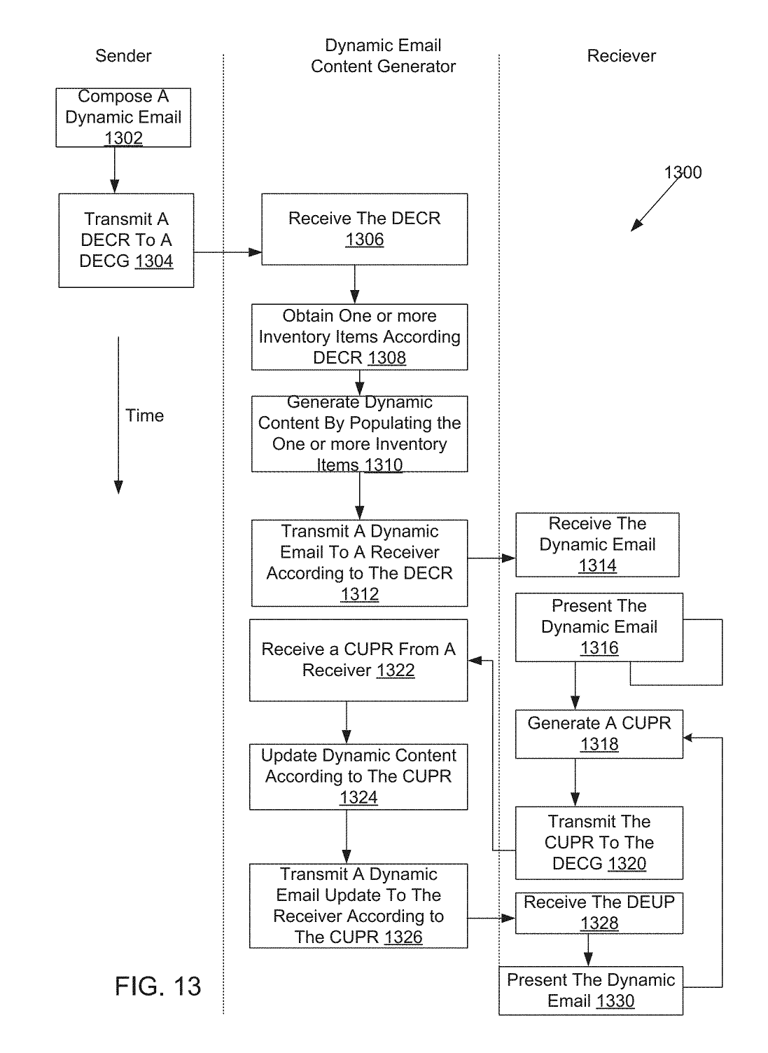

FIG. 13 illustrates an example process 1300 for facilitating dynamic email in accordance with the disclosure. The method presented in FIG. 13 and described below is intended to be illustrative and non-limiting. The particular series of processing steps depicted in FIG. 13 is not intended to be limiting. It is appreciated that the processing steps may be performed in an order different from that depicted in FIG. 13 and that not all the steps depicted in FIG. 13 need be performed. In certain implementations, the method 1300 may be implemented by a receiver, a sender, a dynamic email content generator, such as sender 102, the receiver 104, and the dynamic email content generator 106 shown in FIG. 1. FIG. 13 will be described with reference to FIG. 1.

In some embodiments, the method depicted in method 1300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1300 in response to instructions stored electronically on an electronic storage medium. The one or more processing devices may include one or more devices configured through hardware, firmware, and/or software to be specifically designed for execution of one or more of the operations of method 1300.

At 1302, a dynamic email can be composed on by a sender. Composing the dynamic email at 1302 may involve providing static content for the dynamic email and/or creating placeholders for the dynamic content. In some implementations, operations involved in 1302 may be implemented by an email composer the same or substantially similar to the email composer 304 illustrated and described herein.

At 1304, a DECR can be generated and transmitted to a dynamic email content generator. In some embodiments, the dynamic email composed at 1302 may comprise a DECR. However, this is not necessarily the only case. In some embodiments, the DECR can be separated generated for populating the dynamic content in the dynamic email. In those embodiments, the DECR may comprise static portion of the dynamic email composed at 1302. In those embodiments, the dynamic email have placeholders to be populated. In some implementations, operations involved in 1304 may be implemented by an email composer the same or substantially similar to the email composer 304 illustrated and described herein.

At 1306, the DECR generated and transmitted at 1304 can be received by a dynamic email content generator. In some implementations, operations involved in 1306 may be implemented by dynamic content request receiver the same or substantially similar to the dynamic content request receiver 504 illustrated and described herein.

At 1308, one or more inventory items may be obtained for generating the dynamic content in accordance with the DECR received at 1306. In some implementations, operations involved in 1308 may be implemented by dynamic content request receiver the same or substantially similar to the dynamic content request receiver 504 illustrated and described herein.

At 1310, dynamic content may be generated by populating the one or more inventory items obtained at 1308. In some implementations, operations involved in 1310 may be implemented by a dynamic content generation component the same or substantially similar to the dynamic content generation component 508 illustrated and described herein.

At 1312, a dynamic email may be transmitted to a receiver in accordance with the DECR. In some implementations, operations involved in 1312 may be implemented by a network component the same or substantially similar to the network component 512 illustrated and described herein.

At 1314, the dynamic email transmitted at 1312 may be received by a receiver. In some implementations, operations involved in 1314 may be implemented by a network component the same or substantially similar to the network component 412 illustrated and described herein.

At 1316, the dynamic email received at 1314 may be presented to a user. In some implementations, operations involved in 1316 may be implemented by an email presentation component the same or substantially similar to the email presentation component 404 illustrated and described herein.

At 1318, a CUPR may be generated. For example, the CUPR may be generated second time and on after the user opened the dynamic email initially. In some implementations, operations involved in 1318 may be implemented by dynamic content updater the same or substantially similar to the dynamic content updater 510 illustrated and described herein.

At 1320, the CUPR generated at 1318 may be transmitted to a dynamic email content generator. In some implementations, operations involved in 1320 may be implemented by a network component the same or substantially similar to the network component 412 illustrated and described herein.

At 1322, the CUPR transmitted at 1318 may be received. In some implementations, operations involved in 1322 may be implemented by a network component the same or substantially similar to the network component 512 illustrated and described herein.

At 1324, dynamic content in the dynamic email may be updated in accordance with the CUPR. In some implementations, operations involved in 1324 may be implemented by dynamic content updater the same or substantially similar to the dynamic content updater 510 illustrated and described herein.

At 1326, the dynamic content generated at 1324 may be transmitted to the receiver. In some implementations, operations involved in 1326 may be implemented by a network component the same or substantially similar to the network component 512 illustrated and described herein.

At 1328, the updated dynamic content may be received by the receiver. In some implementations, operations involved in 1328 may be implemented by a network component the same or substantially similar to the network component 412 illustrated and described herein.

At 1330, the updated dynamic content may be presented to the user in the dynamic email. In some implementations, operations involved in 1330 may be implemented by dynamic content updater the same or substantially similar to the dynamic content updater 410 illustrated and described herein.

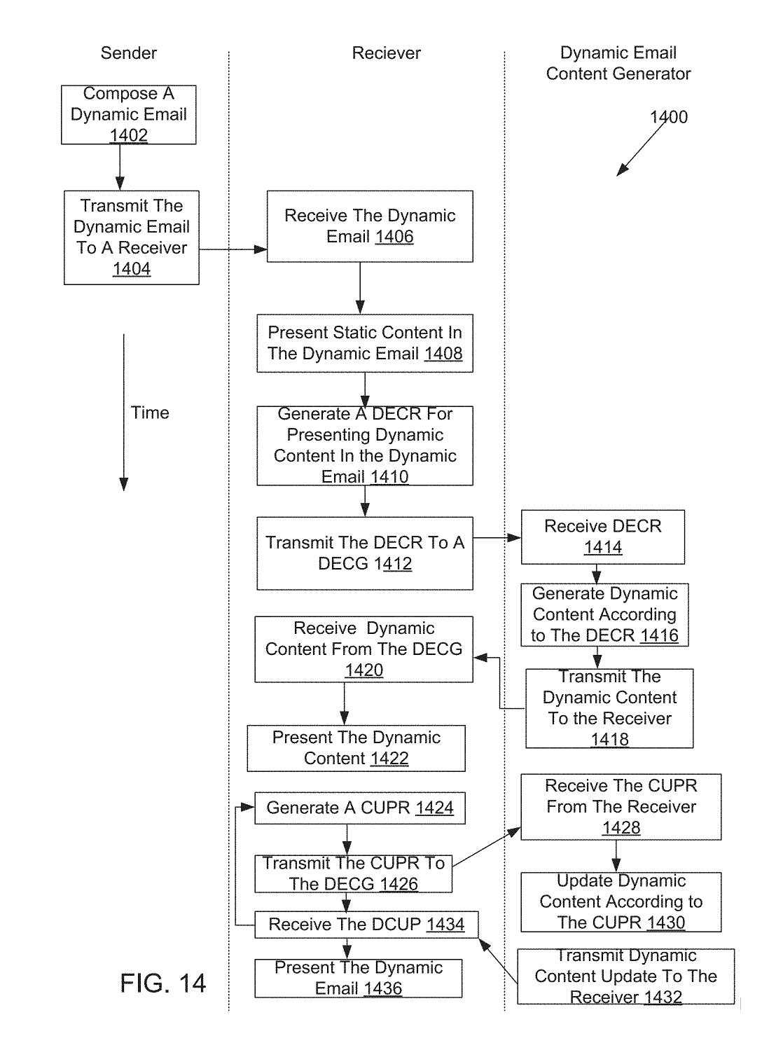

FIG. 14 illustrates another example process 1400 for facilitating dynamic email in accordance with the disclosure. The method presented in FIG. 14 and described below is intended to be illustrative and non-limiting. The particular series of processing steps depicted in FIG. 14 is not intended to be limiting. It is appreciated that the processing steps may be performed in an order different from that depicted in FIG. 14 and that not all the steps depicted in FIG. 14 need be performed. In certain implementations, the method 1400 may be implemented by a receiver, a sender, a dynamic email content generator, such as sender 102, the receiver 104, and the dynamic email content generator 106 shown in FIG. 1. FIG. 14 will be described with reference to FIG. 1.

In some embodiments, the method depicted in method 1400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1400 in response to instructions stored electronically on an electronic storage medium. The one or more processing devices may include one or more devices configured through hardware, firmware, and/or software to be specifically designed for execution of one or more of the operations of method 1400.

At 1402, a dynamic email can be composed on by a sender. Composing the dynamic email at 1402 may involve providing static content for the dynamic email and/or creating placeholders for the dynamic content. In some implementations, operations involved in 1402 may be implemented by an email composer the same or substantially similar to the email composer 304 illustrated and described herein.

At 1404, the dynamic email composed at 1402 can be transmitted to a receiver. In some implementations, operations involved in 1404 may be implemented by a network component the same or substantially similar to the a network component 310 illustrated and described herein.

At 1406, the dynamic email transmitted at 1404 may be received by a receiver. In some implementations, operations involved in 1414 may be implemented by a network component the same or substantially similar to the network component 412 illustrated and described herein.

At 1408, static content in the dynamic email received at 1406 can be presented by the receiver. In some implementations, operations involved in 1408 may be implemented by an email presentation component the same or substantially similar to the email presentation component 404 illustrated and described herein.

At 1410, a DECR can be generated. As mentioned above, the dynamic email may have placeholders to be populated for the dynamic content. When presenting the dynamic email, a DECR may be generated. In some implementations, operations involved in 1410 may be implemented by an email presentation component the same or substantially similar to the email presentation component 404 illustrated and described herein.

At 1412, the DECR may be transmitted to a dynamic email content generator. In some implementations, operations involved in 1412 may be implemented by a network component the same or substantially similar to the network component 412 illustrated and described herein.

At 1414, the DECR transmitted at 1412 can be received by a dynamic email content generator. In some implementations, operations involved in 1414 may be implemented by dynamic content request receiver the same or substantially similar to the dynamic content request receiver 504 illustrated and described herein.

At 1416, dynamic content may be generated according to the DECR received at 1414. This may involve obtaining one or more inventory items in accordance with the DECR received at 1414 and populating the one or more inventory items in the placeholders in the DECR. In some implementations, operations involved in 1416 may be implemented by a dynamic content generation component the same or substantially similar to the dynamic content generation component 508 illustrated and described herein.

At 1418, the dynamic content generated at 1416 may be transmitted to the receiver in accordance with the DECR. In some implementations, operations involved in 1418 may be implemented by a network component the same or substantially similar to the network component 512 illustrated and described herein.

At 1420, the dynamic content transmitted at 1418 may be received by the receiver. In some implementations, operations involved in 1420 may be implemented by a network component the same or substantially similar to the network component 412 illustrated and described herein.

At 1422, the dynamic content received at 1420 may be presented to the user. In some implementations, operations involved in 1422 may be implemented by an email presentation component the same or substantially similar to the email presentation component 404 illustrated and described herein.

At 1424, a CUPR may be generated. For example, the CUPR may be generated second time and on after the user opened the dynamic email initially. In some implementations, operations involved in 1424 may be implemented by dynamic content updater the same or substantially similar to the dynamic content updater 410 illustrated and described herein.

At 1426, the CUPR generated at 1424 may be transmitted to the dynamic email content generator. In some implementations, operations involved in 1426 may be implemented by a network component the same or substantially similar to the network component 412 illustrated and described herein.

At 1428, the CUPR transmitted at 1426 may be received. In some implementations, operations involved in 1428 may be implemented by a network component the same or substantially similar to the network component 512 illustrated and described herein.

At 1430, dynamic content in the dynamic email may be updated in accordance with the CUPR. In some implementations, operations involved in 1430 may be implemented by dynamic content updater the same or substantially similar to the dynamic content updater 510 illustrated and described herein.

At 1432, the dynamic content updated at 1430 may be transmitted to the receiver. In some implementations, operations involved in 1432 may be implemented by a network component the same or substantially similar to the network component 512 illustrated and described herein.

At 1434, the updated dynamic content may be received by the receiver. In some implementations, operations involved in 1434 may be implemented by a network component the same or substantially similar to the network component 412 illustrated and described herein.

At 1436, the updated dynamic content may be presented to the user in the dynamic email. In some implementations, operations involved in 1436 may be implemented by dynamic content updater the same or substantially similar to the dynamic content updater 410 illustrated and described herein.

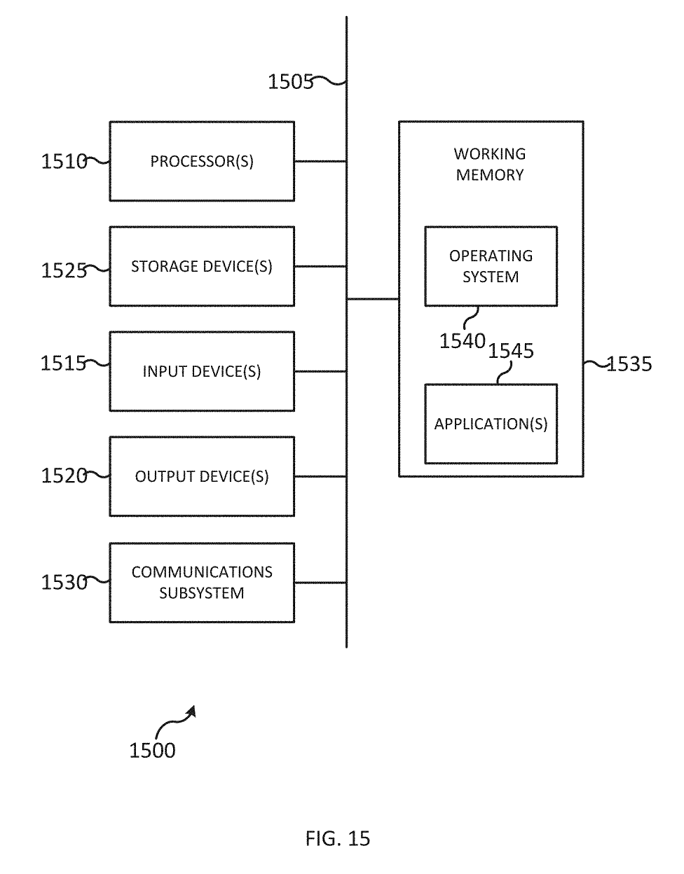

FIG. 15 illustrates a simplified computer system that can be used implement various embodiments described and illustrated herein. A computer system 1500 as illustrated in FIG. 15 may be incorporated into devices such as a portable electronic device, mobile phone, or other device as described herein. FIG. 15 provides a schematic illustration of one embodiment of a computer system 1500 that can perform some or all of the steps of the methods provided by various embodiments. It should be noted that FIG. 15 is meant only to provide a generalized illustration of various components, any or all of which may be utilized as appropriate. FIG. 15, therefore, broadly illustrates how individual system elements may be implemented in a relatively separated or relatively more integrated manner.

The computer system 1500 is shown comprising hardware elements that can be electrically coupled via a bus 1505, or may otherwise be in communication, as appropriate. The hardware elements may include one or more processors 1510, including without limitation one or more general-purpose processors and/or one or more special-purpose processors such as digital signal processing chips, graphics acceleration processors, and/or the like; one or more input devices 515, which can include without limitation a mouse, a keyboard, a camera, and/or the like; and one or more output devices 1520, which can include without limitation a display device, a printer, and/or the like.

The computer system 1500 may further include and/or be in communication with one or more non-transitory storage devices 1525, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 1500 might also include a communications subsystem 1530, which can include without limitation a modem, a network card (wireless or wired), an infrared communication device, a wireless communication device, and/or a chipset such as a Bluetooth™ device, an 1502.11 device, a WiFi device, a WiMax device, cellular communication facilities, etc., and/or the like. The communications subsystem 1530 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 1530. In other embodiments, a portable electronic device, e.g. the first electronic device, may be incorporated into the computer system 1500, e.g., an electronic device as an input device 1515. In some embodiments, the computer system 1500 will further comprise a working memory 1535, which can include a RAM or ROM device, as described above.

The computer system 1500 also can include software elements, shown as being currently located within the working memory 1535, including an operating system 1540, device drivers, executable libraries, and/or other code, such as one or more application programs 1545, which may comprise computer programs provided by various embodiments, and/or may be designed to implement methods, and/or configure systems, provided by other embodiments, as described herein. Merely by way of example, one or more procedures described with respect to the methods discussed above, such as those described in relation to FIG. 15, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 1525 described above. In some cases, the storage medium might be incorporated within a computer system, such as computer system 1500. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by the computer system 1500 and/or might take the form of source and/or installable code, which, upon compilation and/or installation on the computer system 1500 e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 1500 to perform methods in accordance with various embodiments of the technology. According to a set of embodiments, some or all of the procedures of such methods are performed by the computer system 1500 in response to processor 1510 executing one or more sequences of one or more instructions, which might be incorporated into the operating system 1540 and/or other code, such as an application program 1545, contained in the working memory 1535. Such instructions may be read into the working memory 1535 from another computer-readable medium, such as one or more of the storage device(s) 1525. Merely by way of example, execution of the sequences of instructions contained in the working memory 1535 might cause the processor(s) 1510 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 1500, various computer-readable media might be involved in providing instructions/code to processor(s) 1510 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 1525. Volatile media include, without limitation, dynamic memory, such as the working memory 1535.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 1510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1500.

The communications subsystem 1530 and/or components thereof generally will receive signals, and the bus 1505 then might carry the signals and/or the data, instructions, etc. carried by the signals to the working memory 1535, from which the processor(s) 1510 retrieves and executes the instructions. The instructions received by the working memory 1535 may optionally be stored on a non-transitory storage device 1525 either before or after execution by the processor(s) 1510.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known to those skilled in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

What is claimed is:

1. A system for facilitating dynamic email content generation, the system comprising one or more processors configured to execute machine readable instructions, the machine readable instructions when executed cause the one or more processors to perform:
receiving a dynamic email content generation request from a sender for facilitating transmission of a dynamic email from the sender to the receiver;
generating a dynamic email content based on the dynamic email content generation request; and
transmitting the dynamic email content to a receiver according to the dynamic email content generation request; and, wherein
generating the dynamic email content comprises:
request an inventory record system to provide inventory information regarding one or more inventory items; and
generating the dynamic email content using the inventory information.

2. The system of claim 1, wherein the one or more processors are further caused to perform:
receiving a dynamic email content update request from the receiver for updating the dynamic email content;
obtaining a content update based on the dynamic email content update request; and
transmitting the content update to the receiver; and, wherein
updating the dynamic email content to obtain a content update further comprises:
requesting the inventory record system to provide updated information regarding the one or more inventory items; and
obtaining the content update using the updated information.

3. The system of claim 1, wherein the dynamic email content generation request includes information regarding the receiver and status information regarding a time period during which the dynamic email is to be active.

4. The system of claim 3, wherein the one or more processors are further caused to perform:
checking whether the dynamic email is valid from time to time based on the status information;
when the dynamic email is valid from time to time, retrieving from the inventory record system the one or more inventory items;
storing the one or more inventory items in a data store.

5. The system of claim 4, wherein the one or more processors are further caused to perform:
receiving an indication that the inventory record system is not available to provide the one or more inventory items; and
in response to receiving the indication, retrieving the one or more inventory items from the data store.

6. The system of claim 1, wherein the one or more processors are further caused to perform:
assigning an identification record to the dynamic email.

7. The system of claim 1, wherein one or more processors are further caused to perform: generating a static email content based on the dynamic email content generation request.

8. The system of claim 1, wherein the dynamic email content generation request is a first dynamic email content generation request, and the dynamic email content is a first dynamic email content and wherein the one or more processors are further caused to perform
receiving a second dynamic email content generation request from the receiver for facilitating presentation of a dynamic email from the sender to the receiver;
generating a second dynamic email content based on the second dynamic email content generation request; and
transmitting the second dynamic email content to the receiver according to the second dynamic email content generation request.

9. The system of claim 1, wherein the dynamic email content generation request is received over a network.

10. The system of claim 1, wherein the dynamic email content is transmitted to the receiver over a network.

11. A method for facilitating dynamic email content generation, the method comprising one or more processors configured to execute machine readable instructions, the machine readable instructions when executed cause the one or more processors to perform:
receiving a dynamic email content generation request from a sender for facilitating transmission of a dynamic email from the sender to the receiver;
generating a dynamic email content based on the dynamic email content generation request; and
transmitting the dynamic email content to a receiver according to the dynamic email content generation request; and, wherein
generating the dynamic email content comprises:
request an inventory record method to provide inventory information regarding one or more inventory items; and
generating the dynamic email content using the inventory information.

12. The method of claim 11, further comprising:
receiving a dynamic email content update request from the receiver for updating the dynamic email content;
obtaining a content update based on the dynamic email content update request; and
transmitting the content update to the receiver; and, wherein
updating the dynamic email content to obtain a content update further comprises:
requesting the inventory record method to provide updated information regarding the one or more inventory items; and
obtaining the content update using the updated information.

13. The method of claim 11, wherein the dynamic email content generation request includes information regarding the receiver and status information regarding a time period during which the dynamic email is to be active.

14. The method of claim 13, further comprising:
checking whether the dynamic email is active from time to time based on the status information;
when the dynamic email is valid from time to time, retrieving from the inventory record method the one or more inventory items;
storing the one or more inventory items in a data store.

15. The method of claim 14, further comprising:
receiving an indication that the inventory record method is not available to provide the one or more inventory items; and
in response to receiving the indication, retrieving the one or more inventory items from the data store.

16. The method of claim 11, further comprising:
assigning an identification record to the dynamic email.

17. The method of claim 11, further comprising: generating a static email content based on the dynamic email content generation request.

18. The method of claim 11, wherein the dynamic email content generation request is a first dynamic email content generation request, and the dynamic email content is a first dynamic email content and wherein the method further comprises:
receiving a second dynamic email content generation request from the receiver for facilitating presentation of a dynamic email from the sender to the receiver;
generating a second dynamic email content based on the second dynamic email content generation request; and
transmitting the second dynamic email content to the receiver according to the second dynamic email content generation request.

19. The method of claim 11, wherein the dynamic email content generation request is received over a network.

20. The method of claim 11, wherein the dynamic email content is transmitted to the receiver over a network.
